(19) United States
(12) Patent Application Publication
(10) Pub. No.: US 2019/0295391 A1
(43) Pub. Date: Sep. 26, 2019

(54) TRANSPARENT MEMBER, IMAGING APPARATUS, AND METHOD OF PRODUCING TRANSPARENT MEMBER

(71) Applicant: CANON KABUSHIKI KAISHA, Tokyo (JP)

(72) Inventor: Yo Watanabe, Tokyo (JP)

(21) Appl. No.: 16/353,973

(22) Filed: Mar. 14, 2019

(30) Foreign Application Priority Data
Mar. 20, 2018 (JP) 2018-052416
Feb. 18, 2019 (JP) 2019-026816

(51) Int. Cl. G08B 13/196; G03B 17/08

(52) U.S. Cl. CPC G08B 13/19617; G03B 17/08; C03C 2217/425; C03C 2217/75; C03C 2217/478

(57) ABSTRACT

The present disclosure provides a transparent member having a highly reliable hydrophilic film formed thereon which can maintain hydrophilicity for a long period of time, even when a product is packed and stored and when the product is exposed to an outdoor environment, wherein the transparent member is a transparent member including a substrate, a porous layer and a hydrophilic polymer layer in this order, wherein the porous layer contains a silica particle and a binder, and the hydrophilic polymer layer contains a polymer having a zwitterionic hydrophilic group having a layer thickness of 1 nm or larger and 20 nm or smaller.

### BACKGROUND

### Field of the Disclosure

The present disclosure relates to a hydrophilic transparent member, and an imaging apparatus using the same as a protective cover.

### Description of the Related Art

In recent years, surveillance cameras are installed in various places such as shops, hotels, banks and stations, for the purpose of crime prevention. The surveillance camera is installed on a ceiling, an outer wall, a support pillar or the like, by a method of mounting, embedding and the like via an installation part.

A transparent protective cover that does not hinder imaging is attached to a main body of the surveillance camera, for the purpose of protecting the camera from a surrounding environment. For the protective cover, a resin material is used which is excellent in transparency and impact resistance such as polycarbonate and acrylic. In the case of a surveillance camera installed outdoors, a video is distorted or blurred when waterdrops such as rain and dew condensation adhere to the protective cover, and accordingly a technology has been widely used which prevents the adhesion of the water droplets by providing a hydrophilic film on the protective cover.

International Publication No. WO2006/011605 discloses a technology of providing a hydrophilic film on a substrate, which includes a porous film containing a metal oxide particle and a hydrophilic polymer film formed on the porous film. In addition, in Japanese Patent Application Laid-Open No. 2017-61598, a hydrophilic film is proposed which has silica and a zwitterionic polymer unevenly distributed on a film surface, by a process of applying a coating agent including a polymerizable monomer, an initiator, silica and the zwitterionic polymer, and curing the coating agent. It is described that a film having a high hydrophilic performance and a high mechanical strength can be obtained by the silica and the zwitterionic polymer being segregated on the surface layer of the polymer film.

### SUMMARY

A transparent member according to the present disclosure is a transparent member including a substrate, a porous layer and a hydrophilic polymer layer, in this order, wherein the porous layer contains a silica particle and a binder; and the hydrophilic polymer layer contains a polymer having a zwitterionic hydrophilic group, and has a layer thickness of 1 nm or larger and 20 nm or smaller.

In addition, an imaging apparatus according to the present disclosure is an imaging apparatus including an optical system and an image sensor which acquires a video via the optical system, in a space surrounded by a housing and a transparent member, wherein the transparent member includes a porous layer and a hydrophilic polymer layer in this order, on a surface in an outer side; the porous layer contains a silica particle and a binder, and the hydrophilic polymer layer contains a polymer having a zwitterionic hydrophilic group, and has a layer thickness of 1 nm or larger and 20 nm or smaller.

In addition, a method of producing a transparent member according to the present disclosure is a method of producing a transparent member including a substrate, a porous layer and a hydrophilic polymer layer, in this order, the method having: applying a dispersion liquid containing a silica particle and a binder component onto a substrate, and curing the dispersion liquid to form the porous layer; and applying a solution containing a polymer having a zwitterionic hydrophilic group onto the porous layer, and curing the solution to form the hydrophilic polymer layer, the hydrophilic polymer layer having a layer thickness of 1 nm or larger and 20 nm or smaller.

Further features of the present disclosure will become apparent from the following description of exemplary embodiments with reference to the attached drawings.

### BRIEF DESCRIPTION OF THE DRAWINGS

FIG. 1 provides a schematic view illustrating a cross section in a thickness direction of one embodiment of a transparent member of the present disclosure.

FIGS. 2A and 2B provide schematic views illustrating one embodiment of an imaging apparatus of the present disclosure.

FIG. 3 provides a schematic view illustrating a configuration example of the imaging apparatus of the present disclosure.

FIG. 4 provides a view illustrating a relationship between an amount of siloxane on a film surface and a contact angle.

### DESCRIPTION OF THE EMBODIMENTS

Preferred embodiments of the present disclosure will now be described in detail in accordance with the accompanying drawings.

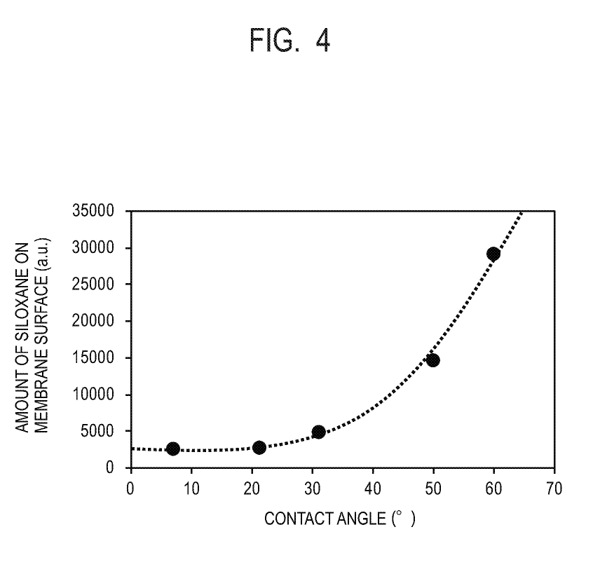

Generally, the camera body and the protective cover of the surveillance camera are stored in the same package, and are shipped. There is a problem that while the camera body and the protective cover are stored in the same package, a component constituting a camera body, in particular, a siloxane-based contaminant contained in a gas which is released from a rubber component adheres to a surface of a hydrophilic film of the protective cover, and results in deteriorating the hydrophilicity. FIG. 4 provides a view illustrating a relationship between an amount of the siloxane on the film surface and a contact angle. It is understood that as the amount of the siloxane which adheres to the film surface increases, the contact angle increases and the hydrophilicity becomes unable to be maintained.

Furthermore, there are problems that the surveillance camera is exposed to sunlight and rain for a long period of time, after having been installed outdoors, thereby the hydrophilic film causes degradation/decomposition, and/or the hydrophilicity results in deteriorating by the adsorption of hydrophobic organic contaminants which drift in the outdoors, or the like.

Accordingly, the protective cover is required to exhibit hydrophilicity over a long period of service from the time when the product has been unpacked and installed outdoors.

As for a countermeasure against the deterioration of the hydrophilicity occurring while being packed and stored, it is considered to provide a protective cover which protects the surface until just before installation. However, it increases cost, and furthermore, in the case of a protective cover having a hemispherical curved surface, a labor and another cost are further needed for providing the protective cover.

Accordingly, it is preferable that the hydrophilic film provided on the protective cover can maintain the hydrophilicity in both of the package storing environment and the outdoor environment. However, in a constitution of International Publication No. WO2006/011605, a siloxane-based contaminant results in adhering to the hydrophilic polymer on the surface while the package is stored, and the hydrophilicity at the time of installation in the outdoor environment cannot be guaranteed. In addition, as for the hydrophilic films proposed in International Publication No. WO2006/011605 and Japanese Patent Application Laid-Open No. 2017-61598, polymers on the surfaces of films which exhibit the hydrophilicity result in being degraded/decomposed by sunlight and rain in the outdoor environment, and cannot maintain the hydrophilicity over a long period of time.

The present disclosure has been designed with respect to the above described problems, and an object of the present disclosure is to provide a transparent member having a hydrophilic coating film, which can maintain the hydrophilicity in both of the package storing environment and the outdoor environment, over a long period of time.

Preferable embodiments of the present disclosure will be described below in detail with reference to the drawings. It should be noted that the present disclosure is not limited to the following embodiments, but can be variously changed within such a range as not to deviate from the scope of the present disclosure.

<<Transparent Member>>

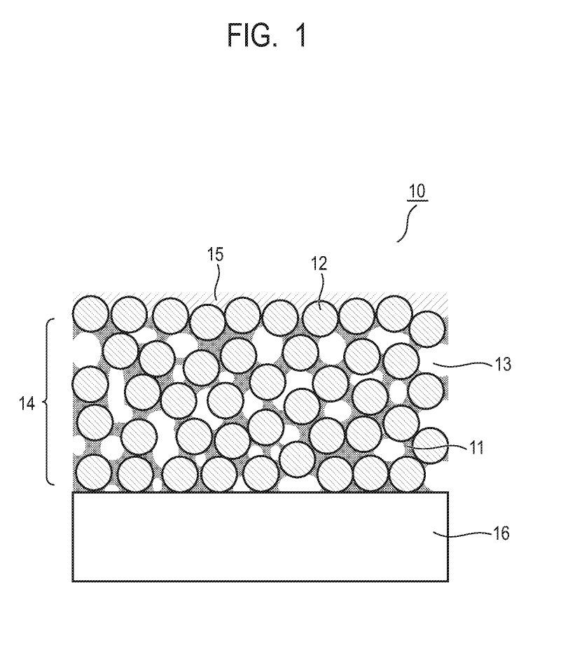

FIG. 1 provides a schematic view illustrating a cross section in the thickness direction (normal direction to surface of substrate), of one embodiment of a transparent member according to the present disclosure. In the figure, the transparent member 10 of the present disclosure has a porous layer 14 and a hydrophilic polymer layer 15, in this order, on a substrate 16. In the present disclosure, “transparent” means such characteristics that a transmissivity to visible light is 50% or higher.

The porous layer 14 includes a plurality of silica particles (silicon oxide particles) 12, and a binder 11 which exists among the plurality of silica particles 12. The plurality of silica particles 12 are fixed to each other by the binder 11, and the porous layer 14 is porous due to voids (void) 13 which are formed in between the silica particles 12 and in between the binder 11. The voids (void) 13 communicate three-dimensionally from the surface of the porous layer 14.

Due to such a structure, the transparent member according to the present disclosure can maintain the hydrophilicity by the hydrophilic polymer layer 15 at the time when having been installed in the package storing environment, and can maintain the hydrophilicity by the porous layer 14 in a period of service after having been installed in the outdoor environment.

Each layer will be described below in detail.

<Hydrophilic Polymer Layer>

The hydrophilic polymer layer 15 is a film for ensuring the hydrophilicity of the surface of the transparent member, under the packing environment and at the time of having been installed in the outdoor environment.

The hydrophilic polymer layer 15 contains a polymer having a zwitterionic hydrophilic group, in order to suppress the adhesion of the siloxane-based contaminant to the hydrophilic surface of the transparent member, in the packing environment. The hydrophilicity of the surface is further enhanced due to the presence of the zwitterionic hydrophilic group, and the electric resistance is lowered. Accordingly, contaminants resist being electrically charged and adhering. As a result, the hydrophilic polymer layer 15 can maintain high hydrophilicity in a long period of storage.

As the zwitterionic hydrophilic group, a sulfobetaine group, a carbobetaine group and a phosphorylcholine group can be suitably used.

The hydrophilic polymer layer 15 exhibits hydrophilicity at the time when installed outdoors, but is decomposed by sunlight and rain while the camera is exposed to the outdoor environment, and the hydrophilicity deteriorates. If the layer thickness of the hydrophilic polymer layer 15 is thick, water droplets result in adhering to the surface because of the deterioration of the hydrophilicity, and a clear image cannot be obtained through the transparent member.

Then, in the present disclosure, the layer thickness of the hydrophilic polymer layer 15 is formed thin so that the hydrophilic polymer layer 15 can be decomposed in the outdoor environment in a short period of time. The porous layer 14 formed of silica particles has high hydrophilicity and is excellent in self-cleaning performance, and accordingly the decomposed hydrophilic polymer is removed from the surface of the porous layer 14. Accordingly, as for the transparent member which has been installed outdoors, a porous layer formed of silica particles is eventually exposed to the surface, and the hydrophilicity is maintained.

It is preferable that the layer thickness of the hydrophilic polymer layer 15 is 1 nm or larger and 20 nm or smaller. When the layer thickness is smaller than 1 nm, the layer is formed in an island shape, and accordingly cannot sufficiently suppress the adsorption of the siloxane-based contaminant onto the surface. When the layer thickness of the hydrophilic polymer layer 15 is larger than 20 nm, it takes time before the porous layer formed of silica particles is exposed under outdoor environment, in the meantime, the zwitterionic hydrophilic group is decomposed, and the surface of a hydrophilic polymer layer 15 becomes hydrophobic and cannot maintain the hydrophilicity. The layer thickness of the hydrophilic polymer layer 15 referred here means a thickness of a portion that is formed on the air side of the particles on the outermost surface which constitutes the porous layer. A specific measurement method will be described later.

A polymer which forms the hydrophilic polymer layer 15 is not limited in particular, but a material is preferable which is easily decomposed in an outdoor environment, and an acrylic polymer is particularly preferable of which the light resistance is low.

<Porous Layer>

The porous layer 14 has a structure in which the silica particles 12 are fixed by a binder and the voids are included among the silica particles 12. It is preferable that the porosity of the porous layer 14 is 40% or more and 55% or less. When the porosity of the porous layer 14 is 40% or more, the porous layer can sufficiently take hydrophobic organic contaminants drifting outdoors into the porous inner part when having been exposed to the outdoor environment, and can maintain the hydrophilicity of the surface. When the porosity of the porous layer 14 is 55% or less, a haze of the hydrophilic film is small, and high transparency is obtained. Furthermore, in order to maintain the hydrophilicity over a long period of time, it is preferable that the layer thickness d is 200 nm or larger and 2000 nm or smaller, so as to secure the capacity of the voids which take the organic contaminants therein.

Here, the porosity v is a value that represents a ratio of a volume of the voids contained in the porous layer 14, with respect to the porous layer 14. A method of evaluating the porosity will be described later.

[Silica Particle]

It is preferable that an average particle diameter of the silica particles 12 is 10 nm or more and 60 nm or less. When the average particle diameter of the silica particles 12 is smaller than 10 nm, the void formed among the particles is too small, and it becomes difficult to achieve a desired porosity; and there is a tendency that the porous inner part cannot sufficiently take in the hydrophobic organic contaminants drifting outdoors. If most parts of the organic contaminants adhere to the surface, the surface becomes hydrophobic, and it becomes difficult to maintain the hydrophilicity under the outdoor environment. In addition, if the average particle diameter of the silica particles 12 exceeds 60 nm, the size of the void 13 formed among the particles becomes large, and there is a tendency that scattering occurs due to the voids 13 and the silica particles 12.

Here, the average particle diameter of the silica particles 12 is an average Feret diameter. The average Feret diameter can be measured by subjecting an observed image which has been acquired by a transmission electron microscope image, to image processing. As for an image processing method, a commercially available image processing such as image Pro PLUS (made by Media Cybernetics Inc.) can be used. In a predetermined image region, a contrast is appropriately adjusted as needed, then, the average Feret diameter of each particle can be measured by using a commercially available particle measuring software, and the average value can be determined.

As for the silica particle 12, a solid silica particle or a hollow silica particle can be used, but a chain silica particle is particularly preferable, in view of being capable of increasing the porosity without generating a large void. It is also acceptable to mix the chain silica particle with the solid silica particle or the hollow silica particle, and use the resultant particle.

The silica particle 12 contains SiO₂ as a main component, but may also contain metal oxides such as Al₂O₃, TiO₂, ZnO₂ and ZrO₂, in the particle. However, if 30% or more of the silanol (Si—OH) groups on the surface of the silica particle 12 are modified by an organic group or the like, or complexed with another metal, the hydrophilicity results in being lost. The porous layer 14 formed of such a silica particle has low hydrophilicity, and lowers also a self-cleaning property.

Accordingly, in order to make the porous layer 14 develop adequate hydrophilicity, it is preferable to use a silica particle in which silanol (Si—OH) groups remain on 70% or more of the particle surface, and it is more preferable to use a silica particle in which silanol (Si—OH) groups remain on 90% or more of the particle surface.

[Binder]

The binder 11 can be appropriately selected depending on the abrasion resistance, adhesion strength and environmental reliability of the film, but a silica (SiO₂) binder is preferable which has high compatibility with the silica particle 12 and can improve the abrasion resistance of the porous layer. Among the silica binders, a silicate hydrolysis condensate is particularly preferable.

It is preferable for the content of the binder 11 to be 2 mass % or more and 30 mass % or less, and is more preferable to be 3 mass % or more and 20 mass % or less, with respect to the porous layer 14. When the content of the binder 11 is 2 mass % or more and 30 mass % or less, the binder 11 can not only fix the silica particles 12 so as not to come loose and fall, but also can achieve a porosity necessary for sufficiently taking organic contaminants into the porous inner part.

<Substrate>

A material which can be used for the substrate 16 includes a resin such as a transparent acrylic resin, a polycarbonate resin and a polyester resin; and glass. The shape of the substrate 16 is not limited; may be a plate shape or a film shape; may be a flat shape, or a shape having a curved surface, a concave surface or a convex surface; and may also be, for example, a hemispherical dome shape.

<Production Method>

Next, one example of a method of producing a transparent member according to the present disclosure will be described below.

The method of producing a transparent member of the present disclosure includes: (i) forming a porous layer on a substrate, and (ii) forming a hydrophilic polymer layer, in this order. Each process will be described below.

(i) Step of Forming Porous Layer

Any of a dry method or a wet method may be used for forming the porous layer 14, but it is preferable to use the wet method which can easily form the porous layer 14.

As the dry method, a deposition method or a sputtering method is used, and the porous layer 14 can be formed by increasing the pressure in the vacuum furnace to form a film, and/or by tilting an incident angle from a direction perpendicular to the substrate to form a film.

Wet methods to be used include a method of sequentially applying and drying a dispersion liquid of the silica particle 12 and a binder solution, and a method of applying and drying a dispersion liquid containing both of the silica particle 12 and the binder component. The method of applying the dispersion liquid containing both of the silica particle and the binder component is preferable, from a viewpoint that the composition inside the porous layer 14 becomes uniform.

The dispersion liquid of the silica particles 12 is a liquid in which the silica particles 12 are dispersed in a solvent, and the content of the silica particles 12 is preferably 2 mass % or more and 10 mass % or less. In order to improve the dispersibility of the silica particles 12, a silane coupling agent and/or a surface-active agent may be added to the dispersion liquid of the silica particles 12. However, when these chemical compounds react with many of the silanol groups on the surface of the silica particle 12, the bonding between the silica particle 12 and the binder 11 becomes weak, and there is a tendency that an abrasion resistance of the porous layer 14 decreases, and/or that the hydrophilicity of the porous layer 14 decreases. Because of this, it is preferable that the additives such as the silane coupling agent and the surface-active agent are 10 parts by mass or less, and more preferably are 5 parts by mass or less, based on 100 parts by mass of the silica particles.

For the binder solution, it is preferable to use a silica binder solution having a strong bonding force with the silica particle 12. It is preferable that the silica binder solution contains a silicate hydrolysis condensate as a main component, which is produced by an operation of adding water, an acid or a base to a silicic acid ester such as methyl silicate and ethyl silicate, in a solvent, and subjecting the mixture to hydrolysis condensation.

The type of acids or bases to be used may be appropriately selected, in consideration of solubility in a solvent and reactivity with a silicic acid ester. Hydrochloric acid or nitric acid is preferable as an acid to be used in the hydrolysis reaction, and ammonia or various amines are preferable as a base to be used. The silica binder solution can be prepared also by a method of neutralizing a silicate such as sodium silicate in water, condensing the product, and then diluting the condensate with a solvent. The acids which can be used for the neutralization reaction are hydrochloric acid, nitric acid and the like. The binder solution can also be heated at a temperature of 80° C. or lower, when being prepared.

When the silica binder is used for the binder 11, a trifunctional silane alkoxide substituted with an organic group such as methyltriethoxysilane and ethyltriethoxysilane can be added, for the purpose of improving the solubility and application properties. The amount of the trifunctional silane alkoxide to be added is preferably 10 mol % or less of the whole silane alkoxide. When the addition amount is more than 10 mol %, there is a tendency that the organic group hinders hydrogen bonding between the silanol groups in the inside of the binder, and the wear resistance lowers.

When the dispersion liquid containing both of the silica particle 12 and the binder component is used, the above described dispersion liquid of the silica particles 12 and the binder solution may be each previously prepared, and then be mixed. Alternatively, the dispersion liquid may be prepared by a method of adding a component of the binder 11 to the dispersion liquid of the silica particles 12, and making the binder and the silica particles react with each other. In the case where the dispersion liquid containing the silica particle 12 and the silica binder component is obtained by using the latter method, the dispersion liquid can be prepared by a method of adding ethyl silicate, water and an acid catalyst to the dispersion liquid of the silica particles 12, and making the substances react with each other. A method of previously preparing the binder solution and then mixing the substances is preferable, from the viewpoint that the method can control the reaction of the binder component and can prepare the dispersion liquid while checking the reaction state.

The amount of the binder in the dispersion liquid containing the silica particles 12 and the silica binder component is preferably 5 parts by mass or more and 35 parts by mass or less, and more preferably is 10 parts by mass or more and 20 parts by mass or less, based on 100 parts by mass of the silica particles.

The solvent that can be used for the dispersion liquid of the silica particles and for the silica binder solution may be any solvent as long as the raw material is uniformly dissolved or dispersed therein, and the reactant does not precipitate. The examples include: monovalent alcohols such as methanol, ethanol, 1-propanol, 2-propanol, 1-butanol, 2-butanol, 2-methylpropanol, 1-pentanol, 2-pentanol, cyclopentanol, 2-methylbutanol, 3-methylbutanol, 1-hexanol, 2-hexanol, 3-hexanol, 4-methyl-2-pentanol, 2-methyl-1-pentanol, 2-ethylbutanol, 2,4-dimethyl-3-pentanol, 3-ethylbutanol, 1-heptanol, 2-heptanol, 1-octanol and 2-octanol; dihydric or higher alcohols such as ethylene glycol and triethylene glycol; ether alcohols such as methoxyethanol, ethoxyethanol, propoxyethanol, isopropoxyethanol, butoxyethanol, 1-methoxy-2-propanol, 1-ethoxy-2-propanol and 1-propoxy-2-propanol; ethers such as dimethoxyethane, diglyme, tetrahydrofuran, dioxane, diisopropyl ether, dibutyl ether and cyclopentyl methyl ether; esters such as ethyl formate, ethyl acetate, n-butyl acetate, ethylene glycol monomethyl ether acetate, ethylene glycol monoethyl ether acetate, ethylene glycol monobutyl ether acetate and propylene glycol monomethyl ether acetate; various aliphatic or alicyclic hydrocarbons such as n-hexane, n-octane, cyclohexane, cyclopentane and cyclooctane; various aromatic hydrocarbons such as toluene, xylene and ethylbenzene; various ketones such as acetone, methyl ethyl ketone, methyl isobutyl ketone, cyclopentanone and cyclohexanone; various chlorinated hydrocarbons such as chloroform, methylene chloride, carbon tetrachloride and tetrachloroethane; and aprotic polar solvents such as N-methylpyrrolidone. N, N-dimethylformamide, N, N-dimethylacetamide and ethylene carbonate. Two or more types of solvents selected from these exemplified solvents can be mixed and used.

Examples of methods for applying the dispersion liquid of the silica particles 12 and the solution of the silica binder component, or a mixture thereof, include a spin coating method, a blade coating method, a roll coating method, a slit coating method, a printing method and a dip coating method. In the case where a transparent member having a sterically-complicated shape such as a concave surface is produced, the spin coating method is preferable from the viewpoint of the uniformity of the film thickness.

After the dispersion liquid of the silica particles and the silica binder solution, or a mixed solution thereof have been applied, it is preferable to provide a drying and curing step to form the porous layer 14, in order to improve the abrasion resistance by suppressing an amount of the solvent which remains in the porous layer. The drying and curing step is a step for promoting the removal of the solvent, a reaction of the silica binder component, or a reaction between the silica binder component and the silica particle 12. The temperature of the drying and curing step is preferably 20° C. or higher and 200° C. or lower, and more preferably is 60° C. or higher and 150° C. or lower. If the temperature of the drying and curing step is 20° C. or higher and lower than 200° C., it does not occur that the solvent remains and the abrasion resistance lowers, and also it does not occur that the curing of the binder 11 proceeds excessively and the cracking tends to easily occur in the binder 11, in other words, in the porous layer 14.

It is preferable that the solvent which remains in the porous layer is 3.0 mg/cm³ or less.

In the case where the dispersion liquid of the silica particles 12 and the silica binder solution are sequentially applied, the porous layer 14 can be formed also by a method of: applying the dispersion liquid of the silica particles 12 on a substrate and once subjecting the resultant substrate to a baking step; and then applying the silica binder solution on the baked layer and subjecting the resultant substrate to the drying and curing step.

The above described application step and the drying and curing step may be repeated alternately by a plurality of times so that the porous layer 14 acquires a desired film thickness.

(ii) Step of Forming Hydrophilic Polymer Layer

A step of forming the hydrophilic polymer layer 15 on the porous layer 14 is a step of: applying a solution containing a hydrophilic polymer by a spin coating method, a blade coating method, a roll coating method, a slit coating method, a printing method, a dip coating method and the like; and then curing the solution.

Preferable main chain structures of the hydrophilic polymer, which can be employed, include an acrylic resin, a methacrylic resin, a polyurethane resin, a polyimide resin, a polyamide resin, an epoxy resin, a polystyrene resin and a polyester resin.

As a solvent of the hydrophilic polymer solution, it is preferable to select and use a solvent having high compatibility with the hydrophilic polymer to be used, from among: alcohols such as methyl alcohol, ethyl alcohol, isopropyl alcohol, ethylene glycol, propylene glycol; ketones such as acetone and methyl ethyl ketone; ethers such as diethyl ether and tetrahydrofuran; aromatic hydrocarbon compounds such as benzene, toluene and xylene; aliphatic hydrocarbon compounds such as n-hexane; alicyclic hydrocarbon compounds such as cyclohexane; and acetic acid esters such as methyl acetate and ethyl acetate.

<<Imaging Apparatus>>

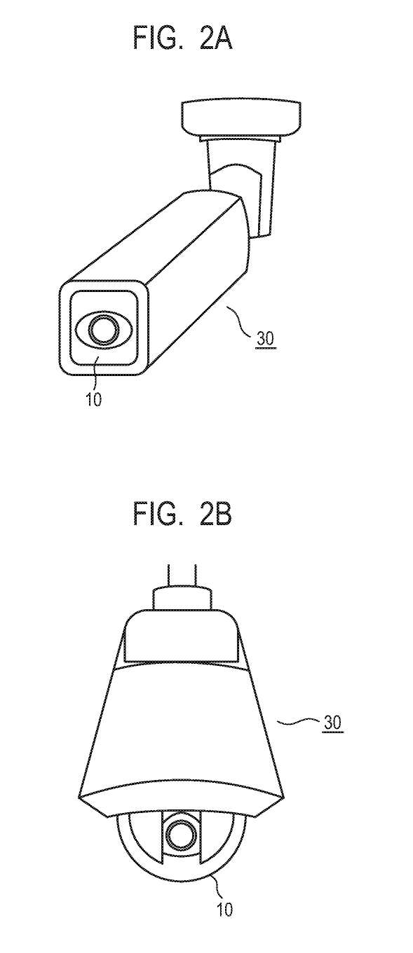

FIGS. 2A and 2B provide schematic views illustrating one embodiment of an imaging apparatus of the present disclosure; FIG. 2A illustrates a fixed-point observation type surveillance camera; and FIG. 2B illustrates a swivel type surveillance camera which can be driven in panning, tilting and zooming operations. The imaging apparatus illustrated in FIGS. 2A and 2B has a transparent member 10 according to the present disclosure, which functions as a protective cover, in a main body 30 of the apparatus, and the main body 30 of the apparatus has an optical system for acquiring video data. In addition, the transparent member (protective cover) 10 covers at least the optical system in the main body 30 of the apparatus, and protects the optical system from dust and impact from the outside. A protective cover 2 in FIG. 2A has a box shape of a planar shape, and a protective cover 2 in FIG. 2B has a dome shape of a semispherical shape; but the shape of the protective cover is not limited to the shapes.

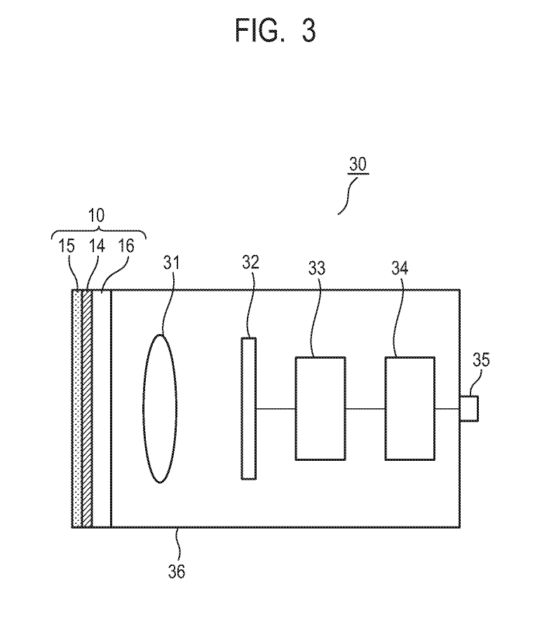

FIG. 3 provides a view illustrating a configuration example of the imaging apparatus according to the present disclosure. The main body 30 of the apparatus has a space surrounded by the transparent member 10 and a housing 36, and includes an optical system 31, an image sensor 32, a video engine 33, a compression output circuit 34 and an output unit 35, in the space.

An image which is acquired via the transparent member 10 is guided to an image sensor 32 by an optical system (lens) 31, is converted into a video analog signal (electric signal) by the image sensor 32, and is output. The video analog signal output from the image sensor 32 is converted into a video digital signal by the video engine 33, and the video digital signal output from the video engine 33 is compressed into a digital file in the compression output circuit 34. The video engine 33 may perform the processing of adjusting an image quality such as luminance, contrast, color correction and noise removal, in a process of converting the video analog signal into the video digital signal. The signal output from the compression output circuit 34 is output from the output unit 35 to external equipment via wiring.

The transparent member 10 is installed so that a surface on which the porous layer 14 and the hydrophilic polymer layer 15 are provided becomes the outer side. Due to such a configuration, protection from the dust and impact from the outside can be achieved, and also water droplets which adhere to the surface of the transparent member 10 because of a change in the external environment can be made into a liquid film, and the distortion of the video which is acquired by the image sensor 32 can be suppressed.

Furthermore, the main body 30 of the apparatus can constitute an imaging system together with a controller for controlling the pan tilt which adjusts an angle of view, imaging conditions and the like, a storage device for storing the acquired video data therein, a transfer unit for transferring the data output from the output unit 35 to the outside, and the like.

### EXAMPLES

A specific method of producing a transparent member according to the present disclosure will be described below.

(Preparation of Coating Liquid)

Firstly, a coating liquid to be used for producing the transparent member according to the present disclosure will be described below.

(1) Preparation of Silica Particle Dispersion

To 50.00 g of a dispersion liquid in which a chain silica particle is dispersed in 2-propanol (IPA) (IPA-ST-UP made by Nissan Chemical Corporation, average particle diameter: 12 nm, and solid content concentration: 15 mass %), 142.50 g of 1-ethoxy-2-propanol was added. After that, IPA was removed by concentration with a rotary evaporator, and a silica particle dispersion liquid A (solid content concentration: 5.0 mass %) was prepared.

(2) Preparation of Silica Binder Solution

To 12.48 g of ethyl silicate, 13.82 g of ethanol and an aqueous solution of nitric acid (concentration: 3%) were added, the resultant liquid was stirred at room temperature for 10 hours, and a silica binder solution (solid content concentration: 11.5 mass %) was prepared.

(3) Preparation of Silica Particle Coating Liquid

After 50.00 g of the silica particle dispersion liquid prepared in (1) was diluted by 65.67 g of 1-ethoxy-2-propanol, then 3.26 g of the silica binder solution prepared in (2) was added to the diluted liquid, and the resultant liquid was stirred at room temperature for 10 minutes. After that, the stirred liquid was stirred at 50° C. for 1 hour, and a silica particle coating liquid B was prepared. It was confirmed with particle size distribution measurement (Zetasizer Nano ZS made by Malvern Panalytical Ltd.) by a dynamic light scattering method that the chain silica particles having a short diameter of 15 nm and a long diameter of 95 nm were dispersed in the silica particle coating liquid B. The content of the binder in the prepared silica particle coating liquid was 13 mass %.

(4) Preparation of Hydrophilic Polymer Coating Liquid A

To 20 g of LAMBIC-771W (made by Osaka Organic Chemical Industry Ltd.) which was an aqueous solution of an acrylic polymer having a sulfobetaine group, 80 g of pure water was added to dilute the LAMBIC-771W, and the diluted solution was stirred at room temperature for 10 minutes.

(5) Preparation of Hydrophilic Polymer Coating Liquid B

To 12 ml of 2-propanol, 2.0 g (19.4 mmol) of anhydrous dimethylaminoacetic acid and 4.2 g (17.8 mmol) of glycidoxypropyltrimethoxysilane were mixed, the mixture was refluxed at 60° C. for 4 hours, the solvent was removed, and a transparent viscous liquid was obtained.

(6) Preparation of Hydrophilic Polymer Coating Liquid C

To 1 g of KPP-05 (made by Koshin Chemical Co., Ltd.) which is an acrylic UV curable coating material having a sulfo group, 100 g of 1-methoxy-2-propanol was added and diluted, and the resultant liquid was stirred at room temperature for 10 minutes.

(7) Preparation of Primer Coating Liquid

To 0.1 g of 3-(2-aminoethylamino) propyltrimethoxysilane (A0774 made by Tokyo Chemical Industry Co., Ltd.) which is amine-based silane, 100 g of 1-methoxy-2-propanol (special grade chemicals made by Kanto Chemical Co., Inc.) was added, and the resultant liquid was stirred at room temperature for 10 minutes.

(Evaluation Method of Transparent Member)

Next, an evaluation method of a transparent member will be described below which is produced with the use of the above described coating liquid.

(8) Measurement of Film Thickness of Porous Layer

The film thickness of the porous layer was measured with the use of a spectroscopic ellipsometer (VASE, made by J. A. Woollam Japan Co. Inc.) at wavelengths in a range of 380 nm to 800 nm, and was determined.

(9) Measurement of Porosity of Porous Layer

A refractive index of the porous layer was measured with the use of a spectroscopic ellipsometer (VASE, made by J. A. Woollam Japan Co. Inc.) at wavelengths of 380 nm to 800 nm, and was determined by the analysis. The porosity of the porous layer was calculated from the refractive index of the porous layer obtained by the measurement, the refractive index of silica of 1.46, and the refractive index of air of 1.00, with the use of Expression 1.

Porosity=100×(1.46−refractive index of porous material)/(1.00−1.46) (Expression 1)

(10) Measurement of Contact Angle to Water

The contact angle at the time when a droplet of 2 μl of pure water contacted at 23° C. and 50% RH was measured, with the use of a fully automatic contact angle meter (DM-701, made by Kyowa Interface Science Co., Ltd.). The contact angle of the transparent member was measured right after the transparent member was produced, and was determined to be an initial value.

(11) Long-Term Storage Test

The produced transparent member was sealed in an aluminum laminate bag of which the inside is laminated with aluminum, and together with 10 g of silicone rubber (Shin-Etsu Chemical Co., Ltd., KE-931-U) which was employed as a siloxane-based contaminant source. The aluminum laminate bag in which the sample was sealed was held for 300 hours, in an environment of a temperature of 60° C. in a thermo-hygrostat (ESPEC Corp., PL-2 KP). The contact angle of the transparent member to water after the test was measured in the same manner as that in (10).

(12) Outdoor Exposure Test

The transparent member, not stored for a long period of time, was charged into a xenon weather meter (Super Xenon Weather Meter CX 75 made by Suga Test Instruments Co., Ltd.). The light irradiation intensity was set at 180 W/m², and one cycle was determined to be light irradiation and water discharge for 18 minutes and only the light irradiation for 1 hour and 42 minutes; and the transparent member was tested for 300 hours in total of 150 cycles in total, and was evaluated once. After that, 150 cycles were further added; and the transparent member was tested for 600 hours in total of 300 cycles in total, and was evaluated again. The contact angle of the transparent member after the test was measured in a similar manner to that in (10). It is considered that 100 hours of this outdoor exposure test correspond to 1 year of the actual outdoor exposure.

(13) Layer Thickness of Hydrophilic Polymer Layer

A concentration of an element originating in the hydrophilic polymer on the surface of the porous layer was measured from the detection intensity at the time when beam conditions were 100 μm, 25 W and 15 kV, with the use of an X-ray photoelectron spectrometer (Quantera II made by ULVAC-PHI Inc.). The element originating in the hydrophilic polymer is measured by use of sulfur in the case where the hydrophilic group of the hydrophilic polymer is, for example, a sulfobetaine group or a sulfo group; of phosphorus in the case where the hydrophilic group is a phosphorylcholine group; and of nitrogen in the case where the hydrophilic group is a carbobetaine group. After that, the similar analysis was repeated 40 times while a region of 2 mm×square was etched by an Ar ion beam with an acceleration voltage of 100V for 15 seconds, and the detection intensity of the element originating in the hydrophilic polymer was measured. The depth of the groove from the surface was measured after 40 times of etching, and as a result, it was confirmed that the depth was approximately 40 nm, and it was found that the hydrophilic polymer layer was etched to a depth of 1 nm by one etching step. Then, the hydrophilic polymer layer was etched from the surface by a plurality of times, and the layer thickness of the hydrophilic polymer layer was determined to be a value which was obtained by multiplying the number of times of etching at the time when the detection intensity of the element originating in the hydrophilic polymer disappeared, by 1 nm.

(14) Evaluation

If the contact angle is smaller than 30°, the surface of the transparent member can sufficiently suppress a water droplet being formed thereon. Accordingly, if the contact angle to water was smaller than 30° in any of the initial value, the long-term storage test, and the outdoor exposure tests for 300 hours and 600 hours, the transparent member was evaluated as A, and if only the contact angle to water after 600 hours of the outdoor exposure test was 300 or larger, the transparent member was evaluated as B. If the contact angle to water was 30° or larger, in any of the initial value, the long-term storage test and the outdoor exposure test of 300 hours, the transparent member was evaluated as C.

### Example 1

In Example 1, an appropriate amount of a primer coating liquid was dropped onto a polycarbonate substrate (nd=1.58 and vd=30.2) having a diameter (ϕ) of 50 mm and a thickness of 4 mm, and was spin coated at 1500 rpm for 30 seconds. After that, the resultant substrate was heated in a hot air circulation oven at 90° C. for 10 minutes, and was dried. By a layer formed from a primer coating liquid being formed on the substrate before the porous layer is formed, the adhesion between the substrate and the porous layer can be enhanced.

Subsequently, a series of steps were repeated 10 times, which dropped an appropriate amount of a silica particle coating liquid onto the substrate, spin coating the liquid at 2000 rpm for 20 seconds, and then heated the substrate in a hot-air circulation oven at 90° C. for 10 minutes, and a porous layer was formed. Furthermore, an appropriate amount of the hydrophilic polymer coating liquid A was dropped on the porous layer, and was spin coated at 3500 rpm for 30 seconds. After that, the substrate was heated in a hot air circulation oven at 80° C. for 15 minutes (drying and curing step). In the end, the substrate was immersed in pure water and was pulled up, the pure water adhering to the substrate was removed from the substrate by dry air being blown, and the transparent member provided with the hydrophilic coating film was obtained.

### Example 2

A transparent member provided with a hydrophilic coating film was produced in a similar manner to that in Example 1, except that a hydrophilic polymer coating liquid was used which was prepared by setting an amount of pure water at 20 g, at the time when the hydrophilic polymer coating liquid A was prepared.

### Example 3

A transparent member provided with a hydrophilic coating film was produced in a similar manner to that in Example 1, except that a hydrophilic polymer coating liquid was used which was prepared by setting an amount of pure water at 300 g, at the time when the hydrophilic polymer coating liquid A was prepared.

### Example 4

At the time when the silica particle coating liquid was prepared, 1-pentanol was used as a solvent for diluting the silica particle dispersion liquid. The number of times of repeating the step of heating the silica coating liquid after having been spin coated was set at 18 times. A transparent member provided with a hydrophilic coating film was produced in a similar manner to that in Example 1, except the above steps.

### Example 5

In Example 5, methyl lactate was used as a diluting solvent for the silica particle dispersion liquid at the time when the silica particle coating liquid was prepared. A transparent member with the hydrophilic coating film was produced in a similar manner to that in Example 1, except that the number of repetitions of the step was changed to 5 times, which applied the chain silica coating liquid by spin coating and then heated the coating liquid.

### Example 6

In Example 6, a transparent member provided with a hydrophilic coating film was produced in a similar manner to that in Example 1, except that the hydrophilic polymer coating liquid B was used.

### Example 7

A transparent member with the hydrophilic coating film was produced in a similar manner to that in Example 1, except that the number of repetitions of the step was set at twice, which applied the silica coating liquid by a spin coating method and then heated the coating liquid.

### Comparative Example 1

A transparent member formed of only the porous layer and provided with a hydrophilic coating film was produced without subjecting the transparent member to the steps subsequent to the step of applying the hydrophilic polymer coating liquid by the spin coating method in Example 1.

### Comparative Example 2

When the silica particle coating liquid was prepared, 2-methoxyethanol was used as the solvent for diluting the silica particle dispersion liquid. In addition, when the hydrophilic polymer coating liquid A was prepared, LAMBIC-771W was not diluted by pure water, but was directly used as the hydrophilic polymer coating liquid. A transparent member provided with a hydrophilic coating film was prepared in a similar manner to that in Example 1, except for the above description.

### Comparative Example 3

After a porous layer was formed in a similar manner to that in Example 1, an appropriate amount of the hydrophilic polymer coating liquid C was dropped on the porous layer, and was spin coated at 3000 rpm for 30 seconds. After that, the substrate was heated in a hot air circulation oven at 80° C. for 10 minutes (drying step). After that, UV irradiation UV irradiation was performed for 10 seconds at a UV intensity of 100 mV/cm² by using a spot UV irradiation unit “Spot Cure” (made by USHIO INC.) (curing step), thereby preparing a transparent member provided with a hydrophilic coating film.

The evaluation results of Examples 1 to 7 and Comparative Examples 1 and 3 are shown in Table 1.

TABLE 1

| | | | | | Contact angle (°) | | | | |
|---|---|---|---|---|---|---|---|---|---|
| | Porous layer | | Hydrophilic polymer | | | Long- | Outdoor | | |
| | Film | | | Film | | term | exposure | | |
| | thickness | Porosity v | Hydrophilic | thickness | | storage | test | | |
| | d (nm) | (%) | group | (nm) | Initial | test | 300 H | 600 H | Determination |
| Example 1 | 1100 | 49 | Sulfobetaine | 5 | 7° | 13° | 11° | 12° | A |
| | | | group | | | | | | |
| Example 2 | 1100 | 49 | Sulfobetaine | 20 | 6° | 10° | 14° | 16° | A |
| | | | group | | | | | | |
| Example 3 | 1100 | 49 | Sulfobetaine | 1 | 7° | 23° | 10° | 12° | A |
| | | | group | | | | | | |
| Example 4 | 2000 | 55 | Sulfobetaine | 5 | 7° | 13° | 9° | 9° | A |
| | | | group | | | | | | |
| Example 5 | 200 | 45 | Sulfobetaine | 5 | 7° | 13° | 13° | 18° | A |
| | | | group | | | | | | |
| Example 6 | 1000 | 49 | Carbobetaine | 5 | 7° | 21° | 10° | 12° | A |
| | | | group | | | | | | |
| Example 7 | 100 | 49 | Sulfobetaine | 5 | 7° | 16° | 25° | 35° | B |
| | | | group | | | | | | |
| Comparative | 1100 | 49 | None | None | 10° | 57° | 12° | 12° | C |
| Example 1 | | | | | | | | | |
| Comparative | 1000 | 60 | Sulfobetaine | 35 | 6° | 10° | 40° | 48° | C |
| Example 2 | | | group | | | | | | |
| Comparative | 1100 | 49 | Sulfo group | 18 | 15° | 35° | 18° | 20° | C |
| Example 3 | | | | | | | | | |

As shown in Table 1, it has been confirmed that when the layer thickness of the hydrophilic polymer layer having a zwitterionic hydrophilic group is 1 nm or larger and 20 nm or smaller, the contact angle to water has been smaller than 30° in any of initial and long-term storage tests and the outdoor exposure test for 300 hours, and that the hydrophilicity is maintained. Furthermore, it has been confirmed that when the film thickness of the porous layer is 200 nm or larger, the contact angle to water has been smaller than 30° in any of the initial and long-term storage tests and the outdoor exposure tests for 300 hours and 600 hours, and that hydrophilicity is maintained over a longer period of time. Meanwhile, in Comparative Example 1 in which the hydrophilic polymer layer was not formed on the surface of the porous layer, the contact angle to water was 57° after the long-term storage test, and the hydrophilicity could not be maintained. In addition, in Comparative Example 2 in which the film thickness and the porosity of the porous layer and the film thickness of the hydrophilic polymer are outside the range of the present disclosure, the contact angle exceeded 30° after the outdoor exposure test, and the hydrophilicity could not be maintained. In addition, in Comparative Example 3 in which the hydrophilic group of the hydrophilic polymer is not a zwitterionic hydrophilic group, the contact angle to water was 350 after the long-term storage test, and the hydrophilicity could not be maintained.

While the present disclosure has been described with reference to exemplary embodiments, it is to be understood that the disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2018-052416, filed Mar. 20, 2018, and Japanese Patent Application No. 2019-026816, filed Feb. 18, 2019, which are hereby incorporated by reference herein in their entirety.

What is claimed is:

1. A transparent member comprising a substrate, a porous layer and a hydrophilic polymer layer, in this order, wherein
the porous layer contains a silica particle and a binder; and the hydrophilic polymer layer contains a polymer having a zwitterionic hydrophilic group having a layer thickness of 1 nm or larger and 20 nm or smaller.

2. The transparent member according to claim 1, wherein the zwitterionic hydrophilic group is selected from the group consisting of a sulfobetaine group, a carbobetaine group and a phosphorylcholine group.

3. The transparent member according to claim 2, wherein a layer thickness of the porous layer is 200 nm or larger and 2000 nm or smaller, and a porosity thereof is 40% or more and 55% or less.

4. The transparent member according to claim 3, wherein the binder is a silica binder.

5. The transparent member according to claim 3, wherein an average particle diameter of the silica particles is 10 nm or larger and 60 nm or smaller.

6. The transparent member according to claim 3, wherein a material of the substrate is selected from the group consisting of an acrylic resin, a polycarbonate resin and a polyester resin.

7. An imaging apparatus comprising an optical system and an image sensor which acquires a video via the optical system in a space surrounded by a housing and a transparent member, wherein
the transparent member comprises a porous layer and a hydrophilic polymer layer from the transparent member side in this order, on a surface in an outer side; the porous layer contains a silica particle and a binder, and
the hydrophilic polymer layer contains a polymer having a zwitterionic hydrophilic group having a layer thickness of 1 nm or larger and 20 nm or smaller.

8. The imaging apparatus according to claim 7, wherein the zwitterionic hydrophilic group is selected from the group consisting of a sulfobetaine group, a carbobetaine group and a phosphorylcholine group.

9. The imaging apparatus according to claim 8, wherein a layer thickness of the porous layer is 200 nm or larger and 2000 nm or smaller, and a porosity thereof is 40% or more and 55% or less.

10. The imaging apparatus according to claim 9, wherein the binder is a silica binder.

11. The imaging apparatus according to claim 9, wherein an average particle diameter of the silica particles is 10 nm or larger and 60 nm or smaller.

12. The imaging apparatus according to claim 9, wherein the transparent member has a flat shape or a dome shape.

13. A method of producing a transparent member comprising a substrate, a porous layer and a hydrophilic polymer layer, in this order, the method comprising:
applying a dispersion liquid containing a silica particle and a binder component onto a substrate, and curing the dispersion liquid to form the porous layer; and
applying a solution containing a hydrophilic polymer having a zwitterionic hydrophilic group onto the porous layer, and curing the solution to form the hydrophilic polymer layer, the hydrophilic polymer layer having a layer thickness of 1 nm or larger and 20 nm or smaller.

14. The method of producing the transparent member according to claim 13, wherein the zwitterionic hydrophilic group is selected from the group consisting of a sulfobetaine group, a carbobetaine group and a phosphorylcholine group.

15. The method of producing the transparent member according to claim 14, wherein the porous layer is formed so that a layer thickness of the porous layer is 200 nm or larger and 2000 nm or smaller, and so that a porosity thereof is 40% or more and 55% or less.

16. The method of producing the transparent member according to claim 15, wherein the silica particle is a chain silica having an average particle diameter of 10 nm or larger and 60 nm or smaller.

17. The method of producing the transparent member according to claim 16, wherein the binder component is a silicate hydrolysis condensate.

18. The method of producing the transparent member according to claim 17, wherein an amount of the binder contained in the dispersion liquid is 5 parts by mass or more and 35 parts by mass or less based on 100 parts by mass of the silica particles.

19. The method of producing the transparent member according to claim 18, further comprising applying a primer coating liquid containing amino-based silane onto the substrate and drying the substrate, before forming the porous layer.
